(19) United States
(12) Patent Application Publication
(10) Pub. No.: US 2019/0050373 A1
(43) Pub. Date: Feb. 14, 2019

(54) APPARATUS, METHOD, AND PROGRAM FOR CALCULATING EXPLANATORY VARIABLE VALUES

(71) Applicant: MIZUHO-DL FINANCIAL TECHNOLOGY CO., LTD., Chiyoda-ku, Tokyo (JP)

(72) Inventors: Yasushi TAKANO, Chiyoda-ku, Tokyo (JP); Ryuichi SATO, Chiyoda-ku, Tokyo (JP); Tatsuro ISHIJIMA, Chiyoda-ku, Tokyo (JP); Kazuyoshi YOSHINO, Chiyoda-ku, Tokyo (JP)

(73) Assignee: MIZUHO-DL FINANCIAL TECHNOLOGY CO., LTD., Chiyoda-ku, Tokyo (JP)

(21) Appl. No.: 15/771,790

(22) PCT Filed: Oct. 20, 2016
(86) PCT No.: PCT/JP2016/081072

§ 371 Date: Oct. 26, 2018

(30) Foreign Application Priority Data
Oct. 30, 2015 (JP) 2015-214654

(51) Int. Cl. G06F 17/18; G06N 7/00

(52) U.S. Cl. CPC G06F 17/18; G06N 7/00

(57) ABSTRACT

Provided is a program causing a computer to execute: a response probability estimation data acquiring step (S201) for acquiring response probability estimation data that defines a relationship between the value of the original variable and a response probability that shows a probability of the response variable being a certain value; an original variable data acquiring step (S202) for acquiring original variable data including realization of the original variable; and an explanatory variable value calculating step (S203, S204) for calculating as an explanatory variable value, an original variable score obtained by calculating an estimated value of the response probability from the realization of the original variable by use of the realization of the original variable and the response probability estimation data, and substituting the estimated value to inverse function of distribution function of predetermined probability distribution.

### TECHNICAL FIELD

The present invention relates to an apparatus, a method, and a program for calculating explanatory variables.

### BACKGROUND ART

Using statistical models, various phenomena, such as a natural phenomenon or a social phenomenon, have been explained and predicted. An example of the statistical model is given by:

$$\{ \begin{matrix}Z = α + {β}_{1} {x}_{1} + {β}_{2} {x}_{2} + … \\ F ( E [ Y ] ) = Z ( 2 )\end{matrix} \qquad ( 1 )$$

where x₁, x₂, . . . represent variables called “explanatory variables”; β₁, β₂, . . . are coefficients respectively corresponding to explanatory variables x₁, x₂, . . . ; and α is a constant.

In Expression 1, Z, defined by the sum of the constant α and a linear combination of explanatory variables and coefficients, is called a linear predictor; and Y is a variable called a response variable. As understood from Expression 2, function F defines a relationship between linear predictor Z and expectation value E[Y] of the response variable Y.

For example, the weight is a response variable and the height and waist size can serve as explanatory variables.

One such statistical model is a generalized linear model. Examples of the generalized linear model include a linear regression model, a binomial logit model, and an ordered logit model.

Some data (financial indicator, individual attribute, etc.) usable as explanatory variables in the statistical model may show largely biased distribution. Also, non-monotonic data is often used. If the data having largely biased distribution or the non-monotonic data is directly used as an explanatory variable, it is less likely to obtain a highly precise statistical model.

Thus, certain processing is executed on the data usable as an explanatory variable and the processed data is used as an explanatory variable value. Non-Patent Literature 1 discloses logarithmic transformation as an example of such processing.

### REFERENCE LIST

### Non-Patent Literature

Non-Patent Literature 1: Kei Takeuchi et al., “Dictionary of Statistics”, Toyo Keizai Inc., December, 1989, p. 419)

### SUMMARY OF INVENTION

### Technical Problem

A statistical model can be built even by a neural network or other such techniques. However, such a complicated technique impairs the simplicity of the statistical model. The statistical model given by the above easy-to-understand expressions is often used in practice. Such a simple statistical analysis is yet low in degree of analytical freedom. In order to improve its precision, it is important to calculate an explanatory variable value for analysis in a special manner.

The present invention has been made in view of the above background art, and it is accordingly an object of the invention to calculate an explanatory variable value that ensures both a high precision and simplicity of a statistical model.

### Solution to Problem

In order to achieve the above object, the present invention provides a program for calculating an explanatory variable value in a statistical model of which a response variable is a binary variable, based on a value of an original variable. The program causes a computer to execute: a response probability estimation data acquiring step for acquiring response probability estimation data that defines a relationship between the value of the original variable and an estimated value of a response probability that shows a probability of the response variable being a certain value; an original variable data acquiring step for acquiring original variable data including realization of the original variable; and an explanatory variable value calculating step for calculating as an explanatory variable value, an original variable score obtained by calculating the estimated value of the response probability from the realization of the original variable by use of the realization of the original variable and the response probability estimation data, and substituting the estimated value to inverse function of distribution function of predetermined probability distribution.

According to another aspect of the present invention, provided is a program for calculating an explanatory variable value in a statistical model of which a response variable is a binary variable, based on a value of an original variable. The program causes a computer to execute: an original variable score calculation data acquiring step for acquiring original variable score calculation data that defines a relationship between a value of the original variable and an original variable score when the original variable score is calculated by substituting a response probability estimated from the value of the original variable and showing a probability of the response variable being a certain value, to inverse function of distribution function of predetermined probability distribution; an original variable data acquiring step for acquiring original variable data including realization of the original variable; and an explanatory variable value calculating step for calculating as an explanatory variable value, an original variable score obtained from the realization of the original variable by use of the realization of the original variable and the original variable score calculation data.

According to still another aspect, provided is a program for calculating an explanatory variable value in a statistical model of which a response variable is a binary variable, based on a value of an original variable, the program causing a computer to execute: an explanatory variable value calculation data acquiring step for acquiring explanatory variable value calculation data that defines a relationship between the value of the original variable and the explanatory variable value when the explanatory variable value is calculated by transforming, by linear expression, an original variable score calculated by substituting a response probability estimated from the value of the original variable and showing a probability of the response variable being a certain value, to inverse function of distribution function of predetermined probability distribution; an original variable data acquiring step for acquiring original variable data including realization of the original variable; and an explanatory variable value calculating step for calculating an explanatory variable value from the realization of the original variable by use of the realization of the original variable and the explanatory variable value calculation data.

### Advantageous Effects of Invention

As described above, according to the present invention, it is possible to calculate an explanatory variable value that ensures both high precision and simplicity of a statistical model.

### BRIEF DESCRIPTION OF DRAWINGS

FIG. 1 is an explanatory diagram showing a functional configuration example of a response probability estimation data generating apparatus.

FIG. 2 is an explanatory diagram of a hardware configuration example of the response probability estimation data generating apparatus.

FIG. 3 shows an example of a flowchart of processing executed by the response probability estimation data generating apparatus.

FIG. 4 is an explanatory diagram showing a functional configuration example of an explanatory variable value calculating apparatus.

FIG. 5 shows an example of a flowchart of processing executed by the explanatory variable value calculating apparatus.

FIG. 6 is a graph showing explanatory variable values.

FIG. 7 is a polygonal approximation graph.

### DESCRIPTION OF EMBODIMENTS

Embodiments of the present invention are described below. Note that the present invention is not limited to the following embodiments.

### First Embodiment: Establishment of Credit Evaluating Model Through Logistic Regression Analysis

A statistical model for evaluating the probability of default of a business or individual is referred to as a “credit evaluating model”. A business or person, evaluated as being less likely to default, can be more reliable.

Many credit evaluating models for businesses use as explanatory variables financial indicators derived from a balance sheet and a profit-and-loss statement. Conceivable examples of the financial indicator include capital ratio, years of debt redemption, a current account, and accounts receivable turnover period.

In addition, many credit evaluating models for individuals use as explanatory variables indicators of personal attributes. Conceivable examples of such information include age, number of household members, income, and years of employment.

Information relating to the credit such as business's financial indicators or personal attributes is hereinafter also referred to as “indicator”. This indicator is an original variable from which an explanatory variable is derived.

Here, what is called a “default flag” is a binary variable equal to 1 for defaulting on a debt within a certain period from settlement of accounts, or otherwise 0. The default flag is often used as a response variable in the credit evaluating model, regardless of whether to evaluate a business or individual by use of the credit evaluating model.

Using the aforementioned explanatory and response variables, the credit evaluating model is built through statistical analysis such as logistic regression analysis. Although depending on statistical analyses used, the credit evaluating model provides, as its output, information that represents the credit of a business or individual like credit scores, the probability of default, ratings, etc. Models are referred to in different ways like a credit scoring model and a default probability estimating model, depending on their outputs. They are collectively referred to as a “credit evaluating model” herein.

In building a credit evaluating model, an analytical technique called a logistic regression analysis is often used. According to the logistic regression analysis, a relationship between an explanatory variable and a probability p of response probability, or default flag, being 1 (also referred to as a default probability p) is represented by:

$$logit ( p ) ≡ log ( \frac{p}{1 - p} ) = α + {β}_{1} {X}_{1} + {β}_{2} {X}_{2} + … \qquad ( 3 )$$

where Xₖ (k=1, 2, . . . ) is an explanatory variable; βₖ is a coefficient corresponding to explanatory variable Xₖ; α is a constant; and logit(p) is logit of the default probability p.

An explanatory variable value Xᵢ^{k} relating to a k-th indicator of business i (i indicates a business ID) is calculated from a value of the k-th indicator (also referred to as a k-th original variable value) of the business i as follows:

Xᵢ^{k}=−F⁻¹(pᵢ^{k}) (4)

where pᵢ^{k} is a default probability of the business i, which is estimated from the k-th indicator value of the business i; F is distribution function of certain probability distribution; and F⁻¹ indicates inverse function of the function F.

By taking function F as the distribution function of logistic distribution as below, the explanatory variable value Xᵢ^{k} and the logit(pᵢ^{k}) can satisfy the relationship in Expression 3.

$$F ( x ) = \frac{1}{1 + {e}^{- x}} \qquad ( 5 )$$

As described above, the explanatory variable value Xᵢ^{k} is calculated so that the relationship between the explanatory variable Xₖ and the default probability p agrees with what is presumed in the credit evaluating model, whereby the establishment of a more precise credit evaluating model is expected.

The thus-calculated explanatory variable value Xᵢ^{k} is a quantified one of the credit of the business i that is calculated from the k-th original variable value. By checking the explanatory variable values calculated from different original variable values of the business, the levels of credit evaluated with the respective indicators can be easily grasped. An arbitrary method can be used to obtain by calculation an estimated default probability pᵢ^{k}. In this embodiment, discretization is employed as mentioned below.

Note that linear combination Z of explanatory variables calculated by

Z≡α+β₁X₁+β₂X₂+ (6)

is referred to as Z score. The Z score indicates the business's credit that reflects all explanatory variables used in the credit evaluating model.

A description is first given of how to generate response probability estimation data necessary for calculating the explanatory variable value Xᵢ^{k} and next is given how to calculate the explanatory variable value Xᵢ^{k} based on the response probability estimation data.

### (Generation of Response Probability Estimation Data)

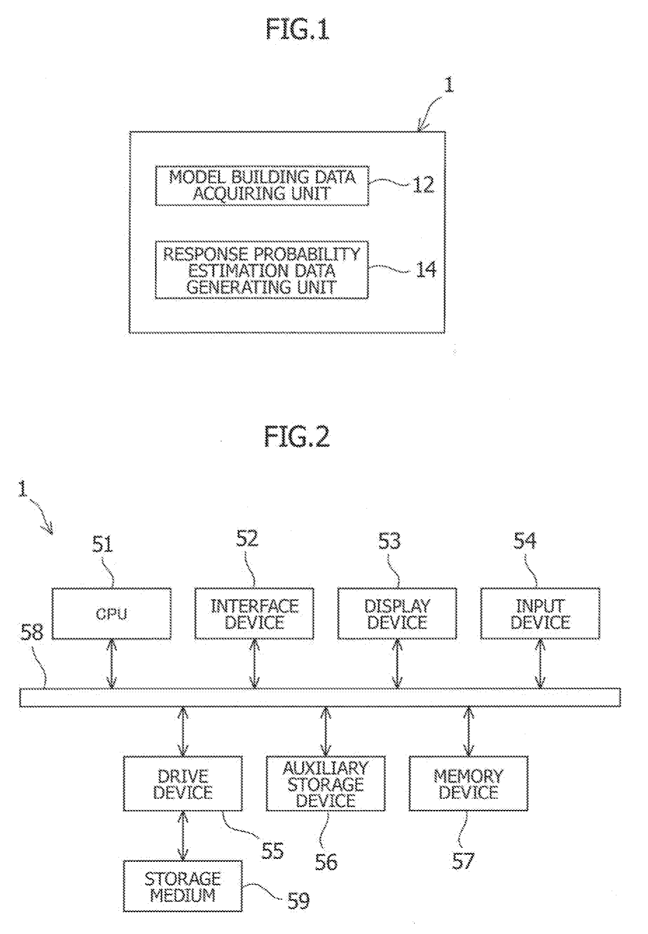

The response probability estimation data is generated by a response probability estimation data generating apparatus 1 of FIG. 1. The response probability estimation data generating apparatus 1 includes a model building data acquiring unit 12 and a response probability estimation data generating unit 14. Each functional unit is detailed below.

FIG. 2 shows an example of the configuration of computer hardware of the response probability estimation data generating apparatus 1. The response probability estimation data generating apparatus 1 includes a CPU 51, an interface device 52, a display device 53, an input device 54, a drive device 55, an auxiliary storage device 56, and a memory device 57, which are mutually connected via a bus 58.

A program for executing functions of the response probability estimation data generating apparatus 1 is provided in the form of being recorded on a recording medium 59 such as a CD-ROM. When the recording medium 59 with the recorded program is inserted into the drive device 55, the program is installed from the recording medium 59 via the drive device 55 to the auxiliary storage device 56. Alternatively, the program can be downloaded via a network from another computer instead of being installed from the recording medium 59. The auxiliary storage device 56 stores the installed program as well as a necessary file, data, etc.

If instructed to activate the program, the memory device 57 reads and stores the program from the auxiliary storage device 56. The CPU 51 executes the functions of the response probability estimation data generating apparatus 1 according to the program stored in the memory device 57. The interface device 52 serves as an interface with another computer via a network. The display device 53 displays a GUI (Graphical User Interface) created by the program, etc. The input device 54 is a keyboard, a mouse, or the like.

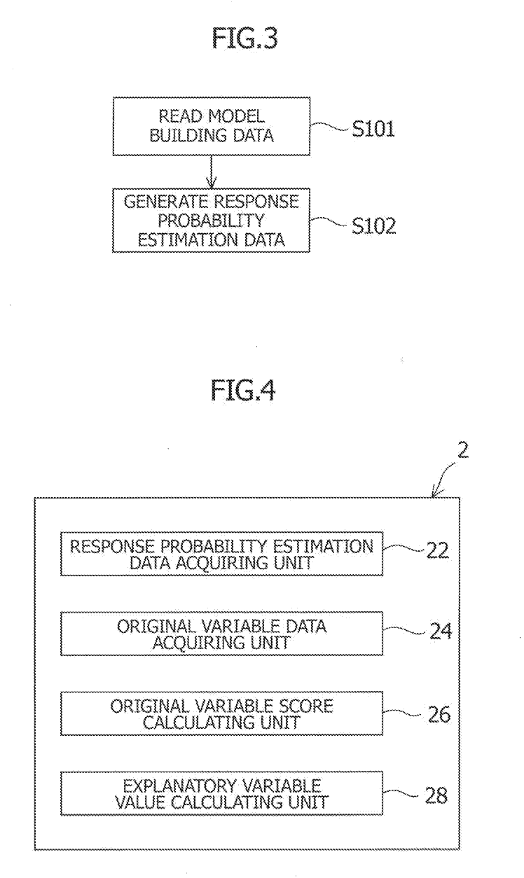

FIG. 3 shows processing executed by the response probability estimation data generating apparatus 1. First of all, in step S101, the model building data acquiring unit 12 reads model building data. Table 1 shows an example of the model building data.

TABLE 1
Model Building Data

| | | | | Financial Indicator (Candidate Explanatory Variable) | | | | | |
|---|---|---|---|---|---|---|---|---|---|
| | | | | | | | | Ratio of | |
| | | | | | | Years of | | Interest | |
| Business Attributes | | | | | Capital | Debt | Current | Burden | |
| Business | Business | Business | Default | Log Sales | Ratio | Redemption | Ratio | to Sales | |
| ID | Name | Type | Flag | (k = 1) | (k = 2) | (k = 3) | (k = 4) | (k = 5) | . . . |
| 1 | Business A | Construction | 0 | 9.016 | 46.82% | 6.43 | 129.95% | 1.29% | . . . |
| 2 | Business B | Manufacturer | 0 | 8.669 | 38.71% | 4.73 | 148.03% | 2.88% | . . . |
| 3 | Business C | Retailer | 1 | 9.474 | 19.86% | 16.82 | 101.74% | 4.51% | . . . |
| 4 | Business D | Supplier | 0 | 10.318 | 64.93% | 2.11 | 211.30% | 0.47% | . . . |
| . | . | . | . | . | . | . | . | . | . . . |
| . | . | . | . | . | . | . | . | . | |
| . | . | . | . | . | . | . | . | . | |

The model building data includes plural samples. Each sample indicates information about a single business. The “default flag” is, as discussed above, a binary variable equal to 1 for defaulting on a debt within a certain period from settlement of accounts, or otherwise 0.

The “financial indicator” in Table 1 is calculated from business's accounting information in a balance sheet, a profit-and-loss statement, etc. For example, “log sales” is the information obtained by logarithmic transformation of sales calculated from the accounting information. The “capital ratio”, “years of debt redemption”, “current ratio”, and “ratio of interest burden to sales” are calculated from the accounting information. These indicators are original variables from which target explanatory variables can be derived. Note that “k” indicates the number assigned to an original variable.

For example, the “capital ratio” of a “business A” with the business ID of “1” is “46.82%”. This value is called realization for the original variable “capital ratio”. Realization of the response variable “default flag” is “0”. As above. Table 1 includes plural samples each containing realizations of plural original variables and that of the response variable. Note that the number of original variables can be any value but one.

In step S102, the response probability estimation data generating unit 14 generates response probability estimation data for an original variable, “capital ratio” (k=2), as shown in Table 2. In this embodiment, the response probability (the probability of response variable being a certain value) means the “default probability” and thus, the response probability estimation data is also referred to as default probability estimation data.

TABLE 2
Response Probability Estimation Data

| | | | Number of Samples | | |
|---|---|---|---|---|---|
| | Capital ratio | | Number | | Estimated |
| Level | Lower limit | Upper limit | of non- | Number of | default |
| No. | (or more) | (less than) | defaults | defaults | probability |
| 1 | — | −10.0% | 2,038 | 987 | 32.63% |
| 2 | −10.0% | −2.0% | 2,219 | 715 | 24.37% |
| 3 | −2.0% | 3.0% | 2,416 | 466 | 16.17% |
| 4 | 3.0% | 10.0% | 2,631 | 279 | 9.59% |
| 5 | 10.0% | 18.0% | 2,865 | 167 | 5.51% |
| 6 | 18.0% | 30.0% | 3,120 | 100 | 3.11% |
| 7 | 30.0% | 45.0% | 3,398 | 60 | 1.74% |
| 8 | 45.0% | 60.0% | 3,701 | 36 | 0.96% |
| 9 | 60.0% | 80.0% | 4,031 | 21 | 0.52% |
| 10 | 80.0% | — | 4,390 | 12 | 0.27% |

The “level No.” in Table 2 indicates numbers assigned to plural levels obtained by discretizing a range of existence of a capital ratio value as a continuous indicator into plural levels. The “lower limit” and “upper limit” of the “capital ratio” indicate upper limits and lower limits of the respective levels. The “number of non-defaults” in the “number of samples” indicates the number of samples whose “default flag” in Table 1 is 0 in each level. The “number of defaults” in the “number of samples” indicates the number of samples whose “default flag” in Table 1 is 1 in each level. The “number of non-defaults” and the “number of defaults” are counted by the response probability estimation data generating unit 14 with reference to the model building data in Table 1.

Moreover, the response probability estimation data generating unit 14 obtains the “estimated default probability” in Table 2 by calculation for each level as follows:

(Estimated default probability)=(the number of defaults)/((the number of non-defaults)+(the number of defaults))

Note that the estimated default probability is also referred to as an “estimated value of response probability”.

In this way, the response probability estimation data is generated for the original variable, “capital ratio”. Regarding original variables other than the “capital ratio” as well, the response probability estimation data can be generated in the same was.

As described above, the response probability estimation data defines the relationship between a value of the original variable and an estimated value of the response probability (estimated default probability).

### (Calculation of Explanatory Variable Value)

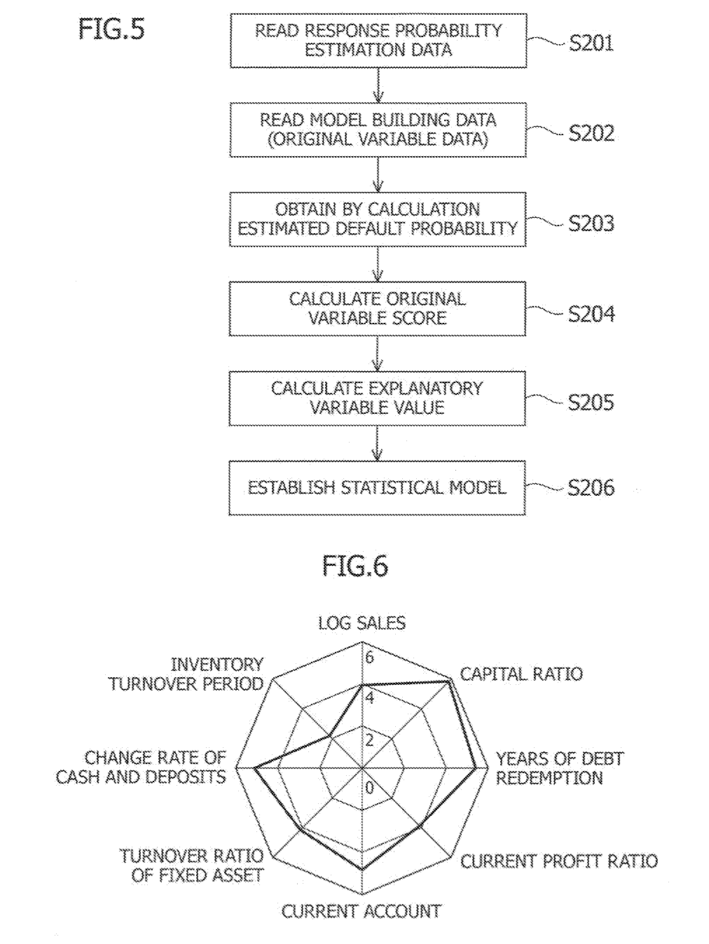

Next, calculation of an explanatory variable value Xᵢ^{k} from the response probability estimation data and subsequent establishment of a statistical model are described. The explanatory variable value is calculated by an explanatory variable value calculating apparatus 2 of FIG. 4. The explanatory variable value calculating apparatus 2 includes a response probability estimation data acquiring unit 22, an original variable data acquiring unit 24, an original variable score calculating unit 26, and an explanatory variable value calculating unit 28. The respective functional units are detailed later. The explanatory variable value calculating apparatus 2 also has the computer hardware configuration of FIG. 2. FIG. 5 is a flowchart of processing executed by the explanatory variable value calculating apparatus 2.

First, in step S201, the response probability estimation data acquiring unit 22 reads the response probability estimation data as shown in Table 2 from the response probability estimation data generating apparatus 1.

In step S202, the original variable data acquiring unit 24 reads the model building data shown in Table 1 from the response probability estimation data generating apparatus 1. As described above, the model building data includes the realization of the original variable and thus is used as original variable data in this embodiment. Note that the original variable data does not need to be the same as the model building data and any data including realization of the original variable suffices for the purpose.

In step S203, the original variable score calculating unit 26 obtains by calculation an estimated default probability for the original variable, “capital ratio” (k=2) with reference to the response probability estimation data (Table 2) and the original variable data (Table 1). Considering the “business A” (i=1), for example, the realization of the capital ratio is “46.82%”. In this case, an estimated default probability pᵢ^{k} is “0.96%”, which is found with reference to level No. 8 in Table 2. Such an estimated default probability for capital ratio is obtained by calculation in connection with every business.

In step S204, the original variable score calculating unit 26 calculates a value called an original variable score from the estimated default probability pᵢ^{k} obtained in step S203 by:

$$( Source Variable Score ) = {F}^{- 1} ( {p}_{i}^{k} ) = log ( \frac{{p}_{i}^{k}}{1 - {p}_{i}^{k}} ) \qquad ( 7 )$$

As described above, function F is a distribution function of a logistic distribution.

In step S205, the explanatory variable value calculating unit 28 calculates the explanatory variable value Xᵢ^{k}. The explanatory variable value Xᵢ^{k} is given by:

Xᵢ^{k}=−(Source Variable Score) (8)

As is understood from the above, the explanatory variable value is obtained by multiplying the original variable score by −1. Needless to say, the explanatory variable value is not limited thereto and can be a value transformed from the original variable score by linear expression. Described so far is a flow up to the calculation of explanatory variable value for the capital ratio.

After that, the explanatory variable value can be similarly calculated for original variables other than the capital ratio (k=2). Then, the statistical model can be built through logistic regression analysis based on explanatory variable values corresponding to all original variables and the default flag as the response variable (step S206). Note that the statistical model can be built by a freely chosen selecting method for an explanatory variable.

Table 3 shows an example of a result of estimating a parameter in establishment of the statistical model. The parameter is a generic term of constant and coefficients in Expression 3.

TABLE 3
Estimated Parameter Values

| Indicator Name | Parameter estimated value |
|---|---|
| Constant α | −5.367 |
| ‘Sales’ coefficient | 0.141 |
| ‘Capital ratio’ coefficient | 0.478 |
| ‘Years of debt redemption’ coefficient | 0.511 |
| ‘Current profit ratio’ coefficient | 0.187 |
| ‘Current account’ coefficient | 0.129 |
| ‘Turnover ratio of fixed asset’ coefficient | 0.241 |
| ‘Change rate of cash and deposits’ | 0.322 |
| coefficient | |
| ‘Inventory turnover period’ coefficient | 0.264 |

The coefficient indicates “how many points of Z score correspond to one point of the explanatory variable value, i.e., how much the Z score changes per point of the explanatory variable value”. A larger coefficient means that an indicator corresponding to the coefficient, i.e., original variable is evaluated as having a large effect.

As understood from the example of Table 3, the years of debt redemption and the capital ratio are influential indicators. According to this embodiment, an effect of an indicator can be readily grasped as above based on a parameter value for an explanatory variable value calculated from the indicator value (original variable value).

Table 4 indicates a result of evaluating credit of a certain business (business A in this example) by use of the credit evaluating model of this embodiment.

TABLE 4
Results of Evaluating Credit

| | Estimated | Explanatory | |
|---|---|---|---|
| | parameter | variable | Contribution |
| Name of indicator | value | value | to score |
| Constant α | −5.367 | — | −5.367 |
| Sales | 0.141 | 3.95 | 0.557 |
| Capital ratio | 0.478 | 5.90 | 2.821 |
| Years of debt | 0.511 | 5.41 | 2.765 |
| redemption | | | |
| Current profit ratio | 0.187 | 3.88 | 0.726 |
| Current account | 0.129 | 4.83 | 0.623 |
| Turnover ratio of fixed | 0.241 | 4.15 | 1.000 |
| asset | | | |
| Change rate of cash | 0.322 | 5.12 | 1.649 |
| and deposits | | | |
| Inventory turnover | 0.264 | 2.18 | 0.576 |
| period | | | |

| | |
|---|---|
| Total (Z score) | 5.349 |
| Estimated PD | 0.47% |

The “estimated parameter value” in Table 4 is already shown in Table 3. The “explanatory variable value” indicates an explanatory variable value calculated by the above method based on the indicator value of the business A. The “contribution to score” indicates the product of an explanatory variable value and a parameter corresponding to each indicator. The sum of constant and contributions to score of every indicator is given as a Z score of the business A. The estimated PD of the business A can be calculated from the Z score. The estimated PD means an estimated default probability that is derived from the Z score.

FIG. 6 is a graph showing explanatory variable values of each indicator for the business A. As is understood from this graph, the business A seems to have a problem in inventory turnover period. As such, in this embodiment, evaluations with each indicator can be easily obtained in addition to final evaluation and compared with one another.

Although the capital ratio as a continuous indicator is mainly discussed above, the same processing is also applicable to categorial indicators. That is, the numbers of default samples and non-default samples are counted for each category, whereby an estimated default probability for each category can be obtained. Regarding samples with a missing value or singular value (e.g., indicator having zero denominator) as well, estimated default probabilities for these samples can be obtained in the same way. Moreover, it is also possible to calculate a default probability with a cross tabulation table of two indicators to find a cross variable.

### REFERENCES

An example of evaluation results with a general credit evaluating model is given below. In most of the general credit evaluating models, a value of original variable is directly used as an explanatory variable value or a log value of the original variable is used as an explanatory variable. Table 5 shows a result of evaluating a certain business with the general credit evaluating model.

TABLE 5
Results of General Credit Evaluating

| | | Explanatory | |
|---|---|---|---|
| | | Variable | Contribution |
| Name of Indicator | Parameter | Value | to score |
| Constant α | −2.367 | — | −2.367 |
| Log sales | 0.1785 | 11.76 | 2.099 |
| Capital ratio | 2.381 | 46.20% | 1.100 |
| Years of debt | 0.411 | 4.33 | 1.780 |
| redemption | | | |
| Current profit ratio | 0.287 | 14.31% | 0.041 |
| Current account | 0.129 | 112.63% | 0.145 |
| Turnover ratio of fixed | 0.0341 | 16.15 | 0.551 |
| asset | | | |
| Change rate of cash | 1.329 | −4.82 | −0.064 |
| and deposits | | | |
| Inventory turnover | 0.264 | 3.68 | 0.972 |
| period | | | |

| | |
|---|---|
| Total (Z score) | 4.256 |
| Estimated PD | 1.40% |

The “explanatory variable value” of Table 5 indicates an indicator itself. However, log values of indicators are used as the sales and inventory turnover period. The “contribution to score” indicates the product of an explanatory variable value and a parameter corresponding to each indicator.

The indicator's standard greatly varies by indicator, and thus, which indicator is focused on cannot be guessed just from parameters in Table 5. Also, when a certain indicator shows high contribution to a score, it is not certain whether the high contribution is based on a favorable “indicator value” or a large parameter value (focused parameter). For example, the contribution to a score of “log sales” is relatively large, but in this case, it cannot be readily determined whether the high contribution is based on high evaluation of sales or an important indicator, albeit an ordinary result of sales evaluation. As such, the evaluation result cannot be easily interpreted with the general credit evaluating model.

### (Modification)

As mentioned above, the original variable score is derived from response probability estimation data (Table 2) based on Expression 7. An explanatory variable value is then derived from the original variable score based on Expression 8. Thus, it is also possible to use original variable score calculation data that defines a relationship between a value of original variable and original variable score in place of the above response probability estimation data. This original variable score calculation data is generated by an original variable score calculation data generating apparatus (not shown) similar to the response probability estimation data generating apparatus 1. The original variable score calculation data generating apparatus includes an original variable score calculation data generating unit (not shown) in place of the response probability estimation data generating unit 14. The original variable score calculation data generating unit generates original variable score calculation data that defines a relationship between a value of the original variable and the original variable score.

Subsequently, the original variable score calculation data is obtained by an original variable score calculating data acquiring unit (not shown) substitute for the response probability estimation data acquiring unit 22 in the explanatory variable value calculating apparatus 2. Then, the original variable score calculating unit 26 calculates an original variable score using the original variable score calculation data.

Alternatively, explanatory variable value calculation data that defines a relationship between a value of original variable and an explanatory variable value can be used in place of the response probability estimation data. The explanatory variable value calculation data is generated by an explanatory variable value calculation data generating apparatus (not shown) similar to the response probability estimation data generating apparatus 1. The explanatory variable value calculation data generating apparatus includes an explanatory variable value calculation data generating unit (not shown) in place of the response probability estimation data generating unit 14. The explanatory variable value calculation data generating unit generates explanatory variable value calculation data that defines a relationship between a value of original variable and an explanatory variable value.

Subsequently, the explanatory variable value calculation data is obtained by an explanatory variable value calculation data acquiring unit (not shown) substitute for the response probability estimation data acquiring unit 22 in the explanatory variable value calculating apparatus 2. In this case, the original variable score calculating unit 26 is not provided and instead, the explanatory variable value calculating unit 28 calculates an explanatory variable value using the explanatory variable value calculation data.

### Second Embodiment: Use of Approximate Expression

According to a second embodiment of the present invention, an approximate expression is used, which represents a relationship between an original variable value and an estimated default probability pᵢ^{k}, upon obtaining by calculation an estimated default probability pᵢ^{k} from the original variable value.

Various methods are conceivable to build an approximate expression. In this embodiment, segmented linear regression is used. The segmented linear regression is to divide a range of existence of original variable into plural segments and then linearly approximate a relationship between the original variable and its estimated default probability in each segment. The relationship between an original variable value such as a financial indicator and an estimated default probability is complicated. Thus, simple linear regression is more likely to have a very large error. The segmented linear regression is, however, expected to improve approximation precision.

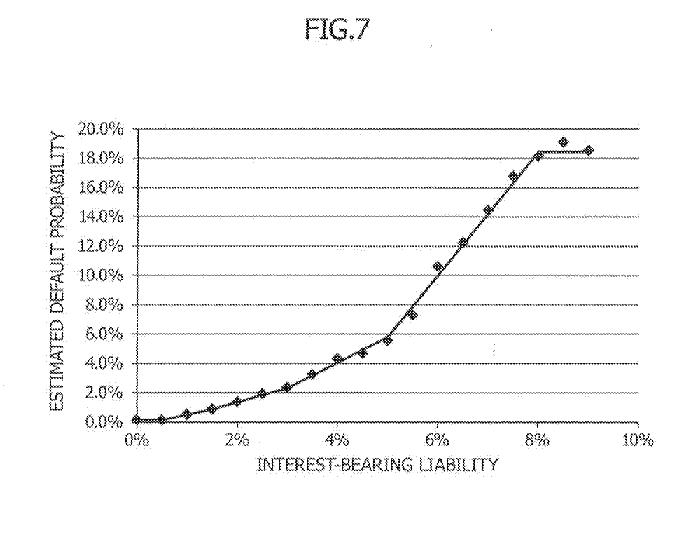

FIG. 7 is a polygonal approximation graph showing a relationship between an original variable value and its estimated default probability for interest-bearing liability as one of the original variables; this relationship is obtained by segmented linear regression. In FIG. 7, square points indicate estimated default probabilities calculated by discretizing original variables. The solid line indicates an approximate polygonal line obtained by segmented linear regression. Calculating estimated default probabilities with this approximate polygonal line provides continuous estimated default probabilities. Consequently, continuous explanatory variable values are obtained.

Table 6 shows an example of deriving, by calculation, an approximate expression representing a relationship between an interest-bearing liability and its estimated default probability based on segmented linear regression.

TABLE 6
Segmented Linear Regression

| | Interest-bearing | | | | Estimated default | | Explanatory | |
|---|---|---|---|---|---|---|---|---|
| Segment | liability | | Function Parameter | | probability | | variable value | |
| No. | Min | Max | Inclination | Segment | Max | Min | Min | Max |
| 1 | 0.00% | 0.50% | 0.0000 | 0.001 | 0.14% | 0.14% | 2.85 | 2.85 |
| 2 | 0.50% | 1.50% | 0.730 | −0.002 | 0.87% | 0.14% | 2.06 | 2.85 |
| 3 | 1.50% | 3.00% | 0.967 | −0.006 | 2.32% | 0.87% | 1.21 | 1.62 |
| 4 | 3.00% | 5.00% | 1.730 | −0.029 | 5.78% | 2.32% | 1.21 | 1.62 |
| 5 | 5.00% | 8.00% | 4.220 | −0.153 | 18.44% | 5.78% | 0.65 | 1.21 |
| 6 | 8.00% | — | 0.000 | 0.184 | 18.44% | 18.44% | 0.65 | 0.65 |

| | | | | | |
|---|---|---|---|---|---|
| — | Interest-bearing | — | — | 0.12% | 2.92 |
| | dept: zero | | | | |
| — | Missing value (except | — | — | 4.83% | 1.29 |
| | interest-bearing | | | | |
| | debt being zero) | | | | |

As shown in Table 6, the segmented linear regression provides threshold values (maximum and minimum values of original variable) in each segment and information about the inclination and intercept in each segment. The inclination and intercept are also referred to as a parameter of function. Then, the maximum and minimum values of estimated default probability in each segment are derived from the threshold value and the function parameter. The maximum and minimum values of the estimated default probability are transformed using inverse function F⁻¹ of function F based on Expression 7 to obtain the maximum and minimum values of the original variable score. Moreover, the maximum and minimum values of the original variable score are linearly transformed by Expression 8 to obtain the maximum and minimum values of the explanatory variable value. Note that in Table 6, the maximum and minimum values of the original variable score are omitted.

Data that contains the “segment No.”, the “interest-bearing liability”, and the “function parameter” in Table 6 corresponds to response probability estimation data of this embodiment. The response probability estimation data defines a relationship between a value of the “interest-bearing liability” as original variable and its estimated default probability. Similar to the first embodiment, the response probability estimation data is generated by the response probability estimation data generating apparatus 1 (see FIGS. 1 and 3).

In this embodiment, the explanatory variable value is also calculated in accordance with the flow of FIG. 5. Specifically, in step S201, the response probability estimation data is read. In step S202, the model building data (Table 1) is read. In step S203, it is determined from the response probability estimation data and the model building data, which section of the response probability estimation data includes realization of an original variable of each sample. Next, a function parameter of a corresponding segment is read. In this step, the estimated default probability is further calculated by:

(Estimated default probability)=(inclination)×(realization of original variable)+(intercept)

In step S204, the original variable score is calculated by Expression 7. In step S205, the explanatory variable value is calculated by Expression 8.

If the interest-bearing dept is zero, the interest-bearing liability cannot be calculated. Also, there is a case that the interest-bearing liability is missing. According to conventional model establishment, if explanatory variables are continuous variables, an ad hoc fashion, i.e., in a fashion of “allocating a worst value” to a sample being a missing value, etc., is used.

As for such samples for which realization of interest-bearing liability cannot be calculated, according to this embodiment, the numbers of non-default samples and default samples are counted up to obtain, by calculation, estimated default probabilities of these samples and then, calculate explanatory variable values from the estimated default probabilities as in the first embodiment. An explanatory variable value corresponding to an estimated default probability can be obtained even for a sample for which realization of interest-bearing liability cannot be calculated, in the same way as a normal sample as described above. Hence, the resultant statistical model is expected to have higher precision.

The same method is applicable to indicators other than the interest-bearing liability. That is, an explanatory variable value is calculated, and the calculated one is used as an explanatory variable and the default flag is used as a response variable to estimate a parameter (constant and coefficient), whereby a credit evaluating model with continuous explanatory variables is built (step S206). Also, in the case of building a model with continuous variables, evaluation, etc. can be carried out for each indicator as in discrete variables.

The approximate expression can be obtained by any method as well as segmented linear regression. For example, polynomial regression, logarithm regression, B-spline, etc. can be adopted.

Also, the estimated default probability can be given by the B-spline in a region where the denominator of the indicator is positive and by the cross tabulation table of indicator numerator and denominator in a region where the denominator of the indicator is negative. As such, the explanatory variable value can be calculated in various ways.

In this embodiment as well, original variable score calculation data that defines a relationship between an original variable value and original variable score can be used in place of the response probability estimation data. Alternatively, explanatory variable value calculation data that defines a relationship between an original variable value and an explanatory variable value can be used in place of the response probability estimation data.

### Third Embodiment: Establishment of Credit Evaluating Model by Probit Regression

Probit regression is often used for building a credit evaluating model like logistic regression. According to the probit regression, a relationship between an explanatory variable and a default probability is represented by:

Φ⁻¹(p)=α+β₁X₁+β₂X₂+ . . .

where Φ is distribution function of standard normal distribution: Φ corresponds to the function F of the first embodiment. The original variable score can be calculated from Expression 7 using inverse function Φ⁻¹ of the function Φ.

This embodiment is the same as the first embodiment except the function F.

Regarding the statistical analysis method for parameter estimation and the distribution function for calculation of indicator score, any particular combination thereof is not necessarily used. For example, the following are also conceivable: an explanatory variable value is calculated using the distribution function of standard normal distribution and a parameter is estimated from the resultant explanatory variable value through the logistic regression analysis.

### Fourth Embodiment: Establishment of Credit Evaluating Model for Each Business Type

As financial features vary by business type, it is very common to build a credit evaluating model for each business type upon actual credit evaluation. In this embodiment, a credit evaluating model is built for each business type.

First, in step S101, the model building data is read. As shown in Table 1, the model building data in this step contains information “business type”. Subsequently, in step S102, response probability estimation data indicating a relationship between a variable value and an estimated value of response probability (estimated default probability) can be generated for each business type. For example, if segmented linear regression is used, a table like Table 6 is generated for each business type. Then, steps S201 to S205 are carried out for each business type and thereafter, in step S206, a credit evaluating model can be built for each business.

Note that the business type is a kind of segment information. The segment information is referenced upon dividing population that is a target for analysis with the statistical model. The population is divided into groups based on segment information. The respective groups are called “segments”. In building the credit evaluating model, it is very common to divide the population into some segments assumed to share the same financial features and build a model for each segment as in this embodiment.

### Advantageous Effects

By building a credit evaluating model based on the thus-calculated explanatory variable values, the built model ensures significantly simple evaluation process and high precision. Also, it can be commonly said that explanatory variable values calculated for every indicator are “absolute standards for credit evaluated by a single indicator”. Thus, the results (levels) of evaluation for each indicator can be easily grasped and indicator-based evaluation results can be compared.

Moreover, in the case of building a model for each business as in the fourth embodiment, indicator-based evaluations for different businesses can be compared. For example, as a standard for an operating profit on sales varies by business, it cannot be easily understood whether the “business A as a retailer with an operating profit on sales of 11%” or the “business B as a service business with the same of 17%” appears to have higher credit. In contrast, the value of explanatory variable obtained by the present invention shows a standard for default probability estimated from an original variable value. Thus, it is possible to compare even the values of different businesses. Considering the above example, the two businesses are compared in terms of explanatory variable value corresponding to the operating profit on sales, making it possible to easily determine which has high credit in terms of operating profit on sales.

Even the indicators of which credit and indicator values are not monotonic can be incorporated into the statistical model with no particular problem. For example, some indicator is considered low in credit (with high default probability) if it is too large or small. According to the first and second embodiments, these indicators are such that large or small values thereof provide small explanatory variables, and mean values thereof provide large explanatory variables. As a result, a monotonic relationship between the explanatory variable value and credit is obtained and easily incorporated into various statistical models.

Also, there is no limitation on a method of obtaining by calculation an estimated default probability from an indicator value and thus, the indicator can be flexibly processed. As described before, it is possible to generate cross variables using a cross tabulation table of two or more indicators or to use different methods of obtaining by calculation estimated default probability according to values of denominator of an indicator.

By utilizing, as distribution function F used for calculating an original variable score, probability distribution corresponding to a desired statistical analysis method for building a model, the resultant model is expected to have higher precision. In general, statistical models are assumed to have a certain relationship between explanatory variable and response variable. If the two variables do not satisfy the assumption, a highly precise model cannot be obtained. For example, in modeling default probability through logistic regression analysis, it is assumed that the logit of default probability is represented by linear expression of explanatory variables (Expression (3)). By utilizing probability distribution corresponding to a desired statistical analysis method for building a model, obtained explanatory variable values ensure that each explanatory variable satisfies the assumption of a corresponding model. Consequently, the model precision is expected to increase. In modeling default probability with a probit model, distribution function of standard normal distribution is used as function F, whereby an explanatory variable value that satisfies the assumption of a model can be obtained.

In one statistical model, it is possible to use both discrete variables obtained by discretion and continuous variables obtained by approximate equation. Regardless of whether an explanatory variable is discrete or continuous one, calculated explanatory variable values have the same definition and thus, explanatory variable values can be compared and evaluated.

### Other Embodiments

The embodiments of the present invention encompass a method and a computer program as well as the apparatus.

The response probability estimation data can be stored in an auxiliary storage device 56 in the response probability estimation data generating apparatus 1 or any external storage device. The same applies to the original variable score calculation data and the explanatory variable value calculation data.

The explanatory variable value calculated by the explanatory variable value calculating apparatus 2 can be stored in the auxiliary storage device in the explanatory variable value calculating apparatus 2 or any external storage device.

The response probability estimation data generating apparatus 1 and the explanatory variable value calculating apparatus 2 can be integrated together.

The model building data read in step S101 can be different from the model building data read in step S202.

The original variable score can be used as an explanatory variable value without being transformed by linear expression.

The present invention enables a wide variety of applications to statistical models represented by Expressions 1 and 2 and also to statistical models of which response variable is binary variable.

The present invention as described thus far is based on the embodiments but is not limited to the above embodiments. The present invention allows various modifications and changes to be made on the basis of the technical concepts of the invention.

### LIST OF REFERENCE SYMBOLS

1 response probability estimation data generating apparatus
12 model building data acquiring unit
14 response probability estimation data generating unit
2 explanatory variable value calculating apparatus
22 response probability estimation data acquiring unit
24 original variable data acquiring unit
26 original variable score calculating unit
28 explanatory variable value calculating unit
51 CPU
52 interface device
53 display device
54 input device
55 drive device
56 auxiliary storage device
57 memory device
58 bus
59 storage medium

1. A program for calculating an explanatory variable value in a statistical model of which a response variable is a binary variable, based on a value of an original variable,
the program causing a computer to execute:
a response probability estimation data acquiring step for acquiring response probability estimation data that defines a relationship between the value of the original variable and an estimated value of a response probability that shows a probability of the response variable being a certain value;
an original variable data acquiring step for acquiring original variable data including realization of the original variable; and
an explanatory variable value calculating step for calculating as an explanatory variable value, an original variable score obtained by calculating the estimated value of the response probability from the realization of the original variable by use of the realization of the original variable and the response probability estimation data, and substituting the estimated value to inverse function of distribution function of predetermined probability distribution.

2. The program according to claim 1, wherein the response probability estimation data includes a parameter of continuous function indicating the relationship.

3. The program according to claim 1, wherein the response probability estimation data includes a plurality of levels obtained by discretizing a range of existence of the value of the original variable and an estimated value of a response probability associated with each of the plurality of levels.

4. The program according to claim 1, wherein the response probability estimation data defines a relationship between the value of the original variable and the estimated value of the response probability on a segment basis,
the original variable data further includes segment information, and
the explanatory variable value calculating step is a step of calculating as an explanatory variable value, an original variable score obtained by calculating the estimated value of the response probability by use of the segment information, realization of the original variable, and the response probability estimation data, and substituting the estimated value to the inverse function of the distribution function of the predetermined probability distribution.

5. A program for calculating an explanatory variable value in a statistical model of which a response variable is a binary variable, based on a value of an original variable,
the program causing a computer to execute:
an original variable score calculation data acquiring step for acquiring original variable score calculation data that defines a relationship between a value of the original variable and an original variable score when the original variable score is calculated by substituting a response probability estimated from the value of the original variable and showing a probability of the response variable being a certain value, to inverse function of distribution function of predetermined probability distribution;
an original variable data acquiring step for acquiring original variable data including realization of the original variable; and
an explanatory variable value calculating step for calculating as an explanatory variable value, an original variable score obtained from the realization of the original variable by use of the realization of the original variable and the original variable score calculation data.

6. The program according to claim 5, wherein the original variable score calculation data includes a parameter of continuous function indicating the relationship.

7. The program according to claim 5, wherein the original variable score calculation data includes a plurality of levels obtained by discretizing a range of existence of the value of the original variable and an original variable score associated with each of the plurality of levels.

8. The program according to claim 5, wherein the original variable score calculation data defines a relationship between the value of the original variable and the original variable score on a segment basis,
the original variable data further includes segment information, and
the explanatory variable value calculating step is a step of calculating as an explanatory variable value, the original variable score obtained with the segment information, realization of the original variable, and original variable score calculation data.

9. The program according to claim 1, wherein the explanatory variable value calculating step is a step of calculating as an explanatory variable, a value obtained by transforming the original variable score by linear expression.

10. A program for calculating an explanatory variable value in a statistical model of which a response variable is a binary variable, based on a value of an original variable,
the program causing a computer to execute:
an explanatory variable value calculation data acquiring step for acquiring explanatory variable value calculation data that defines a relationship between the value of the original variable and the explanatory variable value when the explanatory variable value is calculated by transforming, by linear expression, an original variable score calculated by substituting a response probability estimated from the value of the original variable and showing a probability of the response variable being a certain value, to inverse function of distribution function of predetermined probability distribution;
an original variable data acquiring step for acquiring original variable data including realization of the original variable; and
an explanatory variable value calculating step for calculating an explanatory variable value from the realization of the original variable by use of the realization of the original variable and the explanatory variable value calculation data.

11. The program according to claim 10, wherein the explanatory variable value calculation data includes a parameter of continuous function indicating the relationship.

12. The program according to claim 10, wherein the explanatory variable value calculation data includes a plurality of levels obtained by discretizing a range of existence of the value of the original variable and an explanatory variable value associated with each of the plurality of levels.

13. The program according to claim 10, wherein the explanatory variable value calculation data defines a relationship between the value of the original variable and the explanatory variable value on a segment basis,
the original variable data further includes segment information, and
the explanatory variable value calculating step is a step of calculating the explanatory variable value by use of the segment information, realization of the original variable, and the explanatory variable value calculation data.

14. The program according to claim 1, wherein the predetermined probability distribution is logistic distribution.

15. The program according to claim 1, wherein the predetermined probability distribution comprises standard normal distribution.

16. An apparatus for calculating an explanatory variable value in a statistical model of which a response variable is a binary variable, based on a value of an original variable,
the apparatus comprising:
a response probability estimation data acquiring unit for acquiring response probability estimation data that defines a relationship between the value of the original variable and an estimated value of a response probability that shows a probability of the response variable being a certain value;
an original variable data acquiring unit for acquiring original variable data including realization of the original variable; and
an explanatory variable value calculating unit for calculating as an explanatory variable value, an original variable score obtained by calculating the estimated value of the response probability from the realization of the original variable by use of the realization of the original variable and the response probability estimation data, and substituting the estimated value to inverse function of distribution function of predetermined probability distribution.

17. An apparatus for calculating an explanatory variable value in a statistical model of which a response variable is a binary variable, based on a value of an original variable,
the apparatus comprising:
an original variable score calculation data acquiring unit for acquiring original variable score calculation data that defines a relationship between a value of the original variable and an original variable score when the original variable score is calculated by substituting a response probability estimated from the value of the original variable and showing a probability of the response variable being a certain value, to inverse function of distribution function of predetermined probability distribution;
an original variable data acquiring unit for acquiring original variable data including realization of the original variable; and
an explanatory variable value calculating unit for calculating as an explanatory variable value, an original variable score obtained from the realization of the original variable by use of the realization of the original variable and the original variable score calculation data.

18. The apparatus according to claim 16, wherein the explanatory variable value calculating unit calculates as an explanatory variable value, a value obtained by transforming the original variable score by linear expression.

19. An apparatus for calculating an explanatory variable value in a statistical model of which a response variable is a binary variable, based on a value of an original variable,
the apparatus comprising:
an explanatory variable value calculation data acquiring unit for acquiring explanatory variable value calculation data that defines a relationship between the value of the original variable and the explanatory variable value where the explanatory variable value is calculated by transforming, by linear expression, an original variable score calculated by substituting a response probability estimated from the value of the original variable and showing a probability of the response variable being a certain value, to inverse function of distribution function of predetermined probability distribution;
an original variable data acquiring unit for acquiring original variable data including realization of the original variable; and
an explanatory variable value calculating unit for calculating an explanatory variable value from the realization of the original variable by use of the realization of the original variable and the explanatory variable value calculation data.

20. A method for calculating an explanatory variable value in a statistical model of which a response variable is a binary variable, based on a value of an original variable,
the method comprising:
a response probability estimation data acquiring step for acquiring response probability estimation data that defines a relationship between the value of the original variable and a response probability that shows a probability of the response variable being a certain value;
an original variable data acquiring step for acquiring original variable data including realization of the original variable; and
an explanatory variable value calculating step for calculating as an explanatory variable value, an original variable score obtained by calculating an estimated value of the response probability from the realization of the original variable by use of the realization of the original variable and the response probability estimation data, and substituting the estimated value to inverse function of distribution function of predetermined probability distribution.

21. A method for calculating an explanatory variable value in a statistical model of which a response variable is a binary variable, based on a value of an original variable,
an original variable score calculation data acquiring step for acquiring original variable score calculation data that defines a relationship between a value of the original variable and ann original variable score where the original variable score is calculated by substituting a response probability estimated from the value of the original variable and showing a probability of the response variable being a certain value, to inverse function of distribution function of predetermined probability distribution;
an original variable data acquiring step for acquiring original variable data including realization of the original variable; and
an explanatory variable value calculating step for calculating as an explanatory variable value, an original variable score obtained from the realization of the original variable by use of the realization of the original variable and the original variable score calculation data.

22. The method according to claim 20, wherein the explanatory variable value calculating step is a step of calculating as an explanatory variable value, a value obtained by transforming the original variable score by linear expression.

23. A method for calculating an explanatory variable value in a statistical model of which a response variable is a binary variable, based on a value of an original variable,
the method comprising:
an explanatory variable value calculation data acquiring step for acquiring explanatory variable value calculation data that defines a relationship between the value of the original variable and the explanatory variable value when the explanatory variable value is calculated by transforming, by linear expression, an original variable score calculated by substituting a response probability estimated from the value of the original variable and showing a probability of the response variable being a certain value, to inverse function of distribution function of predetermined probability distribution;
an original variable data acquiring step for acquiring original variable data including realization of the original variable; and
an explanatory variable value calculating step for calculating an explanatory variable value from the realization of the original variable by use of the realization of the original variable and the explanatory variable value calculation data.
